(19) United States
(12) Patent Application Publication
(10) Pub. No.: US 2023/0350030 A1
(43) Pub. Date: Nov. 2, 2023

(54) LIDAR SENSOR

(71) Applicant: Robert Bosch GmbH, Stuttgart (DE)

(72) Inventor: Johannes Richter, Renningen (DE)

(21) Appl. No.: 18/245,498

(22) PCT Filed: Nov. 3, 2021
(86) PCT No.: PCT/EP2021/080465

§ 371 Date: Mar. 15, 2023

(30) Foreign Application Priority Data
Nov. 12, 2020 (DE) 10 2020 214 216.5

(51) Int. Cl. G01S 7/481

(52) U.S. Cl. CPC G01S 7/4817; G01S 7/4814

(57) ABSTRACT

A LIDAR sensor including a transmitting unit, a receiving unit, a rotating deflection unit, and an evaluation unit. The rotating deflection unit deflects laser light, generated by the transmitting unit, into the surroundings in a first rotation angle range of the rotating deflection unit, and guides components of the emitted laser light, reflected in the surroundings, to the receiving unit of the LIDAR sensor, and guides the laser light within the LIDAR sensor to the receiving unit in a second rotation angle range of the rotating deflection unit, without the laser light thus deflected leaving the LIDAR sensor.

### FIELD

The present invention relates to a LIDAR sensor.

### BACKGROUND INFORMATION

Highly automated and fully automated vehicles described in the related art frequently include numerous identical and/or different sensors for detecting the surroundings of the vehicles. For example, video cameras, LIDAR sensors, radar sensors, and ultrasonic sensors are used as such sensors, in particular LIDAR sensors playing an increasingly important role in this field of application. With the aid of laser light, LIDAR sensors allow generation of 3D point clouds of the surroundings.

As one characteristic of LIDAR sensors, LIDAR sensors including a rotating mirror unit are available, in which transmitting modules and receiving modules are fixedly installed on a stator, and in which the laser light is deflected in various spatial directions of the surroundings by the rotating mirror unit. The precise measuring directions of such laser radiation are a function of a particular rotor angle of the mirror unit, and are determined in a calibration step (also referred to below as angle calibration) during manufacture of the LIDAR sensors. During operation of these LIDAR sensors, the particular instantaneous rotor angle is determined by an encoder. However, deviations from the calibrated setpoint values of the particular rotor positions may occur over time, for which reason a recalibration, which is to be carried out in a repair shop, for example, is generally provided in the related art. German Patent Application No. DE 10 2018 201 688 A1 describes a calibration device for calibrating a transmitting device for electromagnetic beams, in particular laser beams, including at least one optics unit for deflecting at least one electromagnetic beam that is emitted by the transmitting device, and including at least one reference unit. In addition, a method for calibrating a transmitting device for electromagnetic beams is described.

European Patent Application No. EP 3229042 A1 describes an optoelectronic sensor and a method for detecting an object and determining the distance from the object in a monitoring range, including a light transmitter for emitting a light beam, including a light receiver for generating reception signals from the light beam that is remitted at the object, including reception optics, situated upstream from the light receiver, for bundling the remitted light beam onto the light receiver, and including an evaluation unit.

### SUMMARY

The present invention provides a LIDAR sensor, in particular a LIDAR sensor for a means of transportation (i.e., a transportation device), that includes a transmitting unit, a receiving unit, a rotating deflection unit, and an evaluation unit. Such a means of transportation is, for example, a road vehicle (a motorcycle, passenger car, van, or truck, for example) or a rail vehicle or an aircraft/airplane and/or a watercraft, and is preferably a means of transportation that uses the LIDAR sensor according to the present invention as a surroundings detection sensor. The evaluation unit is designed, for example, as an ASIC, FPGA, processor, digital signal processor, microcontroller, or the like. The transmitting unit, which is a laser diode, for example, and the receiving unit are preferably components that are immovably mounted within the LIDAR sensor.

According to an example embodiment of the present invention, The rotating deflection unit is configured to deflect laser light, generated by the transmitting unit, into the surroundings of the LIDAR sensor in a first rotation angle range of the rotating deflection unit, and to guide components of the emitted laser light, reflected in the surroundings, to the receiving unit of the LIDAR sensor. Based on a run-time measurement of this laser light received by the receiving unit from the surroundings, it is possible to ascertain a distance from objects in the surroundings of the LIDAR sensor, which reflect the laser light back to the LIDAR sensor. It is noted that the rotating deflection unit may include more than one first rotation angle range, depending on its actual embodiment. This is described in greater detail below in conjunction with the description of advantageous embodiments of the present invention. In addition, the rotating deflection unit is configured to guide laser light, generated by the transmitting unit, within the LIDAR sensor to the receiving unit in a second rotation angle range of the rotating deflection unit, without the laser light thus deflected leaving the LIDAR sensor. It is noted that the rotating deflection unit may include more than one second rotation angle range, depending on its actual embodiment.

According to an example embodiment of the present invention, the evaluation unit is configured to receive a first signal of the receiving unit which represents laser light received by the receiving unit within the first rotation angle range, and to receive a second signal of the receiving unit which represents laser light received by the receiving unit within the second rotation angle range. For this purpose, the evaluation unit is connected to the receiving unit using information technology. A particular point in time for generating the particular signals results, for example, from an exceedance of a threshold value of the start of light entry into the receiving unit, which is brought about by the second rotation angle range. Alternatively or additionally, the point in time is determined based on a maximum light entry into the receiving unit while passing through the second rotation angle range. In addition, further options for determining particular points in time, which represent synchronization points in time, are possible.

According to an example embodiment of the present invention, the evaluation unit is also configured to automatically differentiate the first signal from the second signal, and to check an angle calibration of the rotating deflection unit, based on the second signal. This offers the advantage according to the present invention that an angle calibration is repeatedly checkable during operation of the LIDAR sensor, independently of an encoder used in the related art.

Preferred refinements of the present invention are disclosed herein.

In one advantageous embodiment of the present invention, the rotating deflection unit is configured to deflect the laser light in the first rotation angle range and in the second rotation angle range with the aid of the same mirror unit. In other words, it is possible for the laser light that is emitted by the transmitting unit in the second rotation angle range to be directly reflected to the receiving unit via one or multiple mirrors (also referred to below as deflection mirrors) of the deflection unit, whose main purpose is the above-described deflection of the laser light of the transmitting unit into the surroundings of the LIDAR sensor. For this purpose, it may be necessary for the optical axes (i.e., the main emission axis and the main reception axis) of the transmitting unit and receiving unit, respectively, to be situated not in parallel with one another, but, rather, at a predefined angle with respect to one another. Alternatively or additionally, it is possible for the transmission light beam to have at least a divergence such that in the second rotation angle range it is reflected, at least in part, directly to the receiving unit. Alternatively or additionally, the rotating deflection unit is also configured to deflect the laser light in the first rotation angle range with the aid of a first mirror unit (i.e., with the aid of the deflection mirror(s)) of the deflection unit, and in the second rotation angle range with the aid of a second mirror unit of the deflection unit, whose mirrors are also referred to below as calibration mirrors. This offers the advantage that the particular mirror units are in each case optimally adaptable to their particular main purpose with regard to their particular placement positions and/or orientations and/or optical properties.

The second mirror unit is advantageously situated at a 90° angle with respect to the first mirror unit. This is understood in particular to mean that the second mirror unit is situated with respect to the first mirror unit in such a way that the former moves on a circular path about the rotation axis of the deflection unit, while the mirror surface of the second mirror unit is situated on a side facing away from the rotation axis. It is noted that the orientation of the first and second mirror units is not limited to an angle of 90° with respect to one another.

The first mirror unit preferably includes two mirrors (i.e., scanning mirrors) situated in parallel with a predefined spacing, and whose respective mirror surfaces face away from one another. It is thus possible, after a 180° rotation of the first mirror unit, for the beam that is to be deflected into the surroundings to be deflected once again into the surroundings in order to scan them. In other words, for each of the two mirrors, the rotating scanning unit thus has a first rotation angle range in each case, the first rotation angle ranges in each case being rotated relative to one another by 180° with respect to the rotation axis. Alternatively or additionally, the second mirror unit is situated at at least one edge of the first mirror unit and/or between respective mirrors of the first mirror unit. Analogously to the use of two first mirror units, it is also possible to situate the second mirror unit (with its respective calibration mirrors) at both edges of the first mirror unit, so that the rotating deflection unit thus has two second rotation angle ranges, which likewise are rotated relative to one another by 180° with respect to the rotation axis. In addition, it is possible for the deflection unit to include more than two first mirror units and/or more than two second mirror units.

The optical axis of the transmitting unit, the optical axis of the receiving unit, and the rotation axis of the rotating deflection unit are advantageously arranged in such a way that the stated axes are situated essentially within one plane, and that the second rotation angle range is thus the range in which the mirrors of the first mirror unit are oriented in parallel to the optical axes of the transmitting unit and of the receiving unit. It is noted that the respective axes may deviate from the shared plane in a predefined tolerance range without thus eliminating the effects to be achieved with the aid of the present invention.

In the case that one or multiple second mirror units are used, it is possible for each of the second mirror units to include a calibration mirror, i.e., a mirror that is configured to deflect the laser light, emitted by the transmitting unit in the particular corresponding second rotation angle ranges, directly to the receiving unit. This is possible in particular when the transmission light beam has a correspondingly high divergence and/or when the optical axes of the transmitting unit and of the receiving unit are oriented at a predefined angle with respect to one another, so that the particular optical axes away from the transmitting unit and the receiving unit intersect. The particular second mirror units particularly advantageously include a plurality of calibration mirrors in each case. A particularly suitable number of calibration mirrors for each second mirror unit is two mirrors, which are in each case arrangeable, for example, at an angle of 45° with respect to the optical axes of the transmitting unit or of the receiving unit, so that the light of the transmitting unit is deflected to the receiving unit even when the transmission light beam has a low divergence and the optical axes of the transmitting unit and of the receiving unit are situated essentially in parallel. Such an embodiment thus provides increased flexibility with regard to the placement positions and orientations of particular components of the LIDAR sensor according to the present invention.

Due to the direct reflection of the transmission light beam in the second rotation angle range to the receiving unit, a correspondingly high light intensity in the area of the receiving unit is to be expected, since the light thus deflected is not attenuated on the way into the surroundings of the LIDAR sensor and on the way back to the LIDAR sensor. To avoid a potential accompanying overcontrol of the receiving unit, the second mirror unit advantageously includes a light-attenuating optical filter (a gray filter, for example) that is situated within the optical path of the second mirror unit. Alternatively or additionally, the second mirror unit includes mirrors having a reflectance of 90% maximum, preferably 50% maximum, and particularly preferably 30% maximum, in order to attenuate the light intensity in the area of the receiving unit.

The second mirror unit advantageously includes a beamforming optical element that is a light-scattering lens or light-bundling lens, for example. A light-scattering lens may be used, for example, to reduce the light intensity of the incident laser light on the receiving unit, while a light-bundling lens is usable, for example, for improving a recognition of the synchronization points in time based on the second rotation angle range. Alternatively or additionally, the above effects may also be achieved by inserting an optical diaphragm within the optical path of the second mirror unit.

The evaluation unit is preferably configured to differentiate the first signal from the second signal based on a run time of the laser light between the transmitting unit and the receiving unit, which corresponds to the particular rotation angle, since a run time of the light reflected in the surroundings is correspondingly greater than a run time of the light reflected within the LIDAR sensor. Alternatively or additionally, the evaluation unit is configured to make this differentiation based on a light intensity of the laser light in the receiving unit, which corresponds to the particular rotation angle range, since the light that is reflected in the surroundings has a lower intensity than the light that is reflected within the LIDAR sensor. A further alternative or additional option for the differentiation is to consider a similarity of cyclically received signals of the receiving unit. In particular in conjunction with a movement of the LIDAR sensor in the surroundings, it is to be assumed that successive first signals have less similarity to one another than successive second signals, since the second signals are not influenced by changes in the surroundings of the LIDAR sensor.

A further advantageous embodiment of the present invention provides that the evaluation unit is configured to compare a transmission power of the LIDAR sensor to a predefined setpoint range for the transmission power, based on the second signal. This allows, among other things, monitoring of eye safety of the LIDAR sensor (which is no longer provided in the event of an unintentionally increased transmission power, for example) and/or monitoring of a surroundings recognition quality (which is adversely affected by an unintentionally decreased transmission power, for example).

In one particularly advantageous embodiment of the present invention, the LIDAR sensor is configured to output an indication signal and/or to carry out an automatic recalibration of the rotor angle of the LIDAR sensor, based on a result of the check of the angle calibration.

### BRIEF DESCRIPTION OF THE DRAWINGS

Exemplary embodiments of the present invention are described in greater detail below with reference to the figures.

FIG. 1 shows a schematic top view onto a LIDAR sensor according to the present invention in a first specific example embodiment.

FIG. 2 shows a schematic side view of the LIDAR sensor according to the present invention in the first specific example embodiment.

FIG. 3 shows a schematic side view of a LIDAR sensor according to the present invention in a second specific example embodiment.

### DETAILED DESCRIPTION OF EXAMPLE EMBODIMENTS

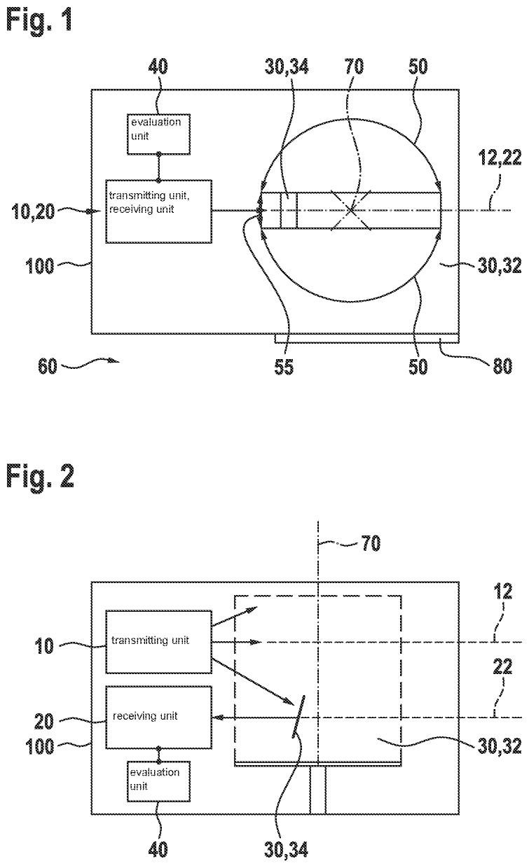

FIG. 1 shows a schematic top view onto a LIDAR sensor according to the present invention in a first specific embodiment, the LIDAR sensor in the present case being a surroundings detection sensor of a road vehicle. The LIDAR sensor includes a housing 100 including a window 80. Window 80 represents an optical interface to surroundings 60 of the LIDAR sensor. Situated in the interior of housing 100 are a transmitting unit 10 that is configured to generate a laser light for scanning surroundings 60, and a receiving unit 20 that is configured to receive components of the laser light that are reflected in the surroundings. In this top view, transmitting unit 10 and receiving unit 20 are situated one on top of the other, and therefore are not individually visible.

An evaluation unit 40, which in the present case is a microcontroller, is connected to receiving unit 20, using information technology. In addition, the LIDAR sensor includes a rotating deflection unit 30 with a first mirror unit 32 that includes two mirrors situated in parallel, each being situated at a rotation axis 70 of deflection unit 30. The mirror surfaces of these two mirrors are each situated on those sides of the mirrors facing away from rotation axis 70. In addition, deflection unit 30 includes a second mirror unit 34 that is situated between the mirrors of first mirror unit 32 at an angle of 90° with respect to the mirrors of first mirror unit 30. Furthermore, optical axis 12 of transmitting unit 10, optical axis 22 of receiving unit 20, and rotation axis 70 are situated essentially in one plane.

Those rotation angle ranges of scanning unit 30 in which the generated laser light of transmitting unit 10 is deflected by first mirror unit 32 in the course of the rotation of deflection unit 30 represent respective first rotation angle ranges 50. This rotation angle range of scanning unit 30 in which the generated laser light is deflected by second mirror unit 34 in the course of the rotation of deflection unit 30 represents a second rotation angle range 55. Whenever the generated laser light strikes second rotation angle range 55, this laser light is deflected by second mirror unit 34 directly onto receiving unit 20.

Evaluation unit 40 is also configured to receive a first signal from receiving unit 20 which represents laser light that is received by receiving unit 20 within first rotation angle ranges 50, and to receive a second signal of receiving unit 20 which represents laser light that is received by receiving unit 20 within second rotation angle range 55. In addition, evaluation unit 40 is configured, based on the above configuration, to automatically differentiate the first signal from the second signal, and to check an angle calibration of rotating deflection unit 30, based on the second signal. For this purpose, evaluation unit 40 in a calibration step compares setpoint calibration values, which in the course of manufacturing the LIDAR sensor have been stored in a memory unit connected to evaluation unit 40, to particular second signals.

In particular, evaluation unit 40 here is configured to make the automatic differentiation between the first signal and the second signal by considering particular run times of the laser light that is represented by the signals.

In addition, evaluation unit 40 here is configured, in the event of an ascertained deviation of an actual angle calibration of the LIDAR sensor from a setpoint angle calibration of the LIDAR sensor, to output an indication signal to a user of the road vehicle that includes the LIDAR sensor. Furthermore, evaluation unit 40 is configured to output a signal to compensate for the deviation of the angle calibration.

In addition, it is possible for evaluation unit 40 to be configured to compare a transmission power of transmitting unit 10 to a predefined setpoint range for the transmission power to allow recognition of a possible risk to eye safety from the LIDAR sensor and initiation of appropriate protective measures (for example, a deactivation of transmitting unit 10).

FIG. 2 shows a schematic side view of the LIDAR sensor according to the present invention in the first specific embodiment. The particular arrangement of above-described transmitting unit 10 and of receiving unit 20, among other things, is apparent from this side view. In addition, it is apparent that second mirror unit 34 in this specific embodiment includes a single mirror, which due to a high divergence of the laser light that is present here, is configured to deflect the laser light in second rotation angle range 55 within the LIDAR sensor to receiving unit 20, without the laser light leaving the LIDAR sensor. With regard to the further integral parts of FIG. 2, reference is made to FIG. 1 to avoid repetitions.

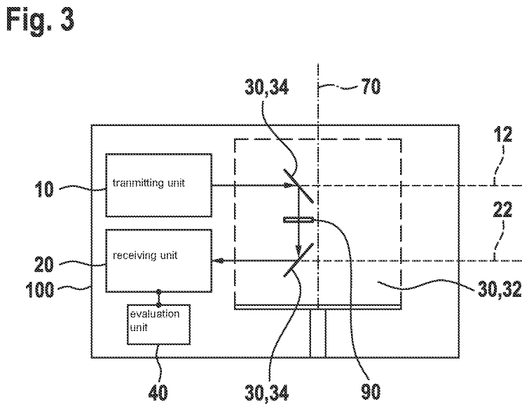

FIG. 3 shows a schematic side view of a LIDAR sensor according to the present invention in a second specific embodiment. It is noted that to avoid repetitions, only the differences from the first specific embodiment illustrated in FIGS. 1 and 2 are described. Due to a low divergence of the emitted laser light, the second specific embodiment provides for using two mirrors within second mirror unit 34, which are arranged in such a way that the laser light in second rotation angle range 55 is initially deflected by the first of the two mirrors in a direction in parallel to the direction of rotation axis 70 of deflection unit 30. The laser light is subsequently deflected essentially along optical axis 22 of receiving unit 20 in the direction of receiving unit 20 with the aid of the second of the two mirrors. Due to the high light intensity of the laser light upon striking receiving unit 20, in the present case a gray filter 90 is provided between the two mirrors, which attenuates the light intensity so that the laser light incident on receiving unit 20 does not result in an overcontrol of receiving unit 20.

Alternatively or additionally, for reducing the light intensity it is possible to insert an optical diaphragm and/or to use light-attenuating mirrors in second mirror unit 34.

1-11. (canceled)

12. A LIDAR sensor, comprising:
a transmitting unit;
a receiving unit;
a rotating deflection unit; and
an evaluation unit;
wherein:
the rotating deflection unit is configured to:
deflect laser light, generated by the transmitting unit, into surroundings of the LIDAR sensor in a first rotation angle range of the rotating deflection unit, and to guide components of the emitted laser light reflected in the surroundings to the receiving unit of the LIDAR sensor, and
deflect the laser light, generated by the transmitting unit, within the LIDAR sensor to the receiving unit in a second rotation angle range of the rotating deflection unit, without the laser light thus deflected leaving the LIDAR sensor,
the evaluation unit is configured to:
receive a first signal of the receiving unit which represents laser light received by the receiving unit within the first rotation angle range,
receive a second signal of the receiving unit which represents laser light received by the receiving unit within the second rotation angle range,
automatically differentiate the first signal from the second signal, and
check an angle calibration of the rotating deflection unit based on the second signal.

13. The LIDAR sensor as recited in claim 12, wherein the rotating deflection unit is configured to:
deflect the laser light in the first rotation angle range and in the second rotation angle range using the same mirror unit of the deflection unit, or
deflect the laser light in the first rotation angle range using a first mirror unit of the deflection unit, and in the second rotation angle range using a second mirror unit of the deflection unit.

14. The LIDAR sensor as recited in claim 13, wherein the second mirror unit is situated at a 90° angle with respect to the first mirror unit.

15. The LIDAR sensor as recited in claim 13, wherein:
the first mirror unit includes two mirrors situated in parallel with a predefined spacing, and whose respective mirror surfaces face away from one another, and/or
the second mirror unit is situated at at least one edge of the first mirror unit and/or between the two mirrors of the first mirror unit.

16. The LIDAR sensor as recited in claim 13, wherein an optical axis of the transmitting unit, an optical axis of the receiving unit, and a rotation axis of the rotating deflection unit are situated essentially in one plane, and the second rotation angle range is a range in which the mirrors of the first mirror unit are oriented essentially in parallel to optical axes of the transmitting unit and of the receiving unit.

17. The LIDAR sensor as recited in claim 13, wherein the second mirror unit is configured to deflect the laser light of the transmitting unit to the receiving unit of the LIDAR sensor using a mirror or a plurality of mirrors.

18. The LIDAR sensor as recited in claim 13, wherein the second mirror unit includes
a light-attenuating optical filter, and/or
mirrors having a reflectance of 90% maximum.

19. The LIDAR sensor as recited in claim 13, wherein the second mirror unit includes:
a beamforming optical element, and/or
an optical diaphragm.

20. The LIDAR sensor as recited in claim 12, wherein the evaluation unit is configured to differentiate the first signal from the second signal based on:
a run time of the laser light between the transmitting unit and the receiving unit, which corresponds to the first or second rotation angle range, and/or
a light intensity of the laser light in the receiving unit, which corresponds to the first or second rotation angle range, and/or
a similarity of cyclically received signals of the receiving unit.

21. The LIDAR sensor as recited in claim 12, wherein the evaluation unit is configured to compare a transmission power of the LIDAR sensor to a predefined setpoint range for the transmission power, based on the second signal.

22. The LIDAR sensor as recited in claim 12, where the LIDAR sensor is configured to, based on a result of the check of the angle calibration:
output an indication signal and/or
carry out an automatic recalibration of a rotor angle of the LIDAR sensor.
